(19) United States
(12) Patent Application Publication
(10) Pub. No.: US 2016/0117673 A1
(43) Pub. Date: Apr. 28, 2016

(54) SYSTEM AND METHOD FOR SECURED TRANSACTIONS USING MOBILE DEVICES

(71) Applicant: Cryptomathic Limited, Cambridge (GB)

(72) Inventors: Mads Landrok, San Jose, CA (US); Peter Landrock, Cambridge (GB)

(21) Appl. No.: 14/808,998

(22) Filed: Jul. 24, 2015

Related U.S. Application Data
(63) Continuation-in-part of application No. 13/404,023, filed on Feb. 24, 2012, now abandoned.

(51) Int. Cl. G06Q 20/38; G06Q 20/32; G06Q 20/40

(52) U.S. Cl. CPC G06Q 20/3829; G06Q 20/409; G06Q 20/4016; G06Q 20/32

(57) ABSTRACT

A secure payment system provisions a payment transaction proxy with virtual EMV-type chipcards on secure backend servers. Users authorize the proxy in each transaction to make payments in the Cloud for them. The proxy carries out the job without exposing the cryptographic keys to risk. User, message, and/or device authentication in multifactor configurations are erected in realtime to validate each user's intent to permit the proxy to sign for a particular transaction on the user's behalf. Users are led through a series of steps by the proxy to validate their authenticity and intent, sometimes incrementally involving additional user devices and communications channels that were pre-registered. Authentication risk can be scored by the proxy, and high risk transactions that are identified are tasked by further incrementally linking in more user devices, communications channels, and user challenges to increase the number of security factors required to authenticate.

### CROSS-REFERENCE TO RELATED APPLICATIONS

This application is a continuation-in-part of U.S. patent application Ser. No. 13/404,023, filed Feb. 24, 2012 and incorporated in its entirety by reference herein.

### BACKGROUND

1. Field

The present application generally relates to mobile payment systems, and in particular to personal trusted devices and applications of users that maintain their authentication and transaction keys in the Cloud, and that authenticate users and their transactions through two-channel handshaking with conventional mobile devices. A proxy in the Cloud is trusted to hold the cryptographic keys and to use them to sign for transactions on behalf of the user.

2. Description of the Related Art

Traditional magnetic stripe based credit and debit cards are now widely used by consumers to make point-of-sale (POS) purchases and online (card-not-present) purchases. Both of these reveal the account number, user's name, and expiry dates to the Merchant and anyone else handed the card, listening in, or with access to the purchase records. In contrast, online PayPal purchases keep most of the user account information away from the merchants, and rely on passwords and email addresses to key up the user's account. PayPal enters the transaction as a sort of proxy or intermediary that both parties trust.

Conventional smart cards are credit card sized devices with embedded tamper-resistant computer chips. When used for security, these chips can store and protect user authentication and transaction credentials, at least to some degree. But, smart card authentication requires a special card reader.

Strong, two-factor authentication is made possible that relies on a PIN or password only the user knows.

Europay, MasterCard, and Visa formed the EMV Company, EMVCo LLC, and now publish the so-called “Integrated Circuit Card Specifications for Payment Systems”. These specifications are related to ISO-7816 and create a common technical basis for card and system implementation of a stored value system. Many new secure ID system implementations are using both biometrics and smart cards to improve the security and privacy of modern ID systems.

VISA's dynamic passcode authentication (DPA) and Mastercard's chip authentication protocol (CAP), enable EMV IC smart cards to secure Internet transactions where the card cannot be read directly by the merchant terminals. The what-you-have security factor in the transaction is therefore not directly available. In the DPA and CAP schemes, the smart card is instead inserted by the cardholder into a private, pocket-sized, dynamic passcode generator and their PIN is entered. If the PIN is correct, a software application on the smart card computes a one-time, time-sensitive passcode, unique to that transaction. Such passcode is read out aloud or entered into a form by the cardholder to complete the transaction. The use of a one-time passcode proves that the actual smart card itself was involved in transaction and that a correct PIN was entered, therefore qualifying as strong, two-factor authentication.

A security authentication module (SAM) card is a smart card similar in appearance to a SIM card. SAM cards typically store cryptographic keys inside point of sale (POS) terminals. Advanced Card Systems, Ltd., (Hong Kong), for example, markets their ACOS6 SAM card as a secure store for cryptographic keys which are used to compute cryptograms in smart payment cards. The terminals do not need to know the master key of an application, and the keys never leave the SAM. Mutual authentication is used to guarantee the authenticity of the terminal and the client card. Secure messaging is used to ensure the data transmission between the card and terminal or server is not vulnerable to eavesdropping, replay attack, or unauthorized modifications. Purse MAC Computation is used to authenticate and ensure data integrity of data and commands that are transferred. Key diversification enables diversified entry of keys without exposing the master key. Secure key injection is used to ensure the key injection from SAM to client cards. Proprietary information stored in each SAM is used to verify the validity of the card.

Unfortunately, the distribution of new SAM-enabled SIM cards to smartphone subscribers is logistically complex, and the end users need to be trained in their use. Mobile payment users must either install a SAM in each of their devices, or buy devices that already have a SAM or a built-in secure element (SE). If implemented responsibly, the results will be secure. But this approach has significant business hurdles to being practical. Mobile network providers (MNPs) control the SAMs and the SEs, issuing banks typically control the payment schemes, and the two have no history of effective cooperation, so being able to deploy a system that works is not assured.

The recently announced ISIS mobile payment system includes an app to store credit card information on near field communication (NFC) enabled smartphones, ISIS enabled point of sale (POS) terminals, and even ISIS price tags. This electronic wallet is supposed to help a user avoid carrying actual and numerous cards in a conventional wallet. So, instead of swiping a traditional credit card and signing or entering PIN to approve the payment, users tap their mobile devices on ISIS-enabled POS terminals. The tap is sensed by accelerometers wired to trigger and identify the parties in an electronic payment to be credited from the user account to the merchant. ISIS cards can be used to electronically wallet a broad range of accounts: credit cards, debit cards, reward cards, discount coupons, payment coupons, tickets, transit passes, etc.

Mobile handheld devices like smart smartphones, tablets, ultrabooks, and other personal trusted devices (PTD's) have become ubiquitous, all-in-one assistants that provide us all with phone, email, encyclopedia, diary, calendar, and many more valuable, instant services. Now these PTD's are also fast becoming our wallets and keys.

In the 1990's, Europay, MasterCard, and Visa (EMV) decided in Europe to switch from magstripe to “smart” chipcard and encryption technology. The changeover is still not complete twenty years later because the magstripe technology was and is so well entrenched, especially in the United States. The EMV chipcard technology enables each payment cards to generate corresponding digital signatures that can be used to secure transactions. Although inherently more secure than the magnetic stripe cards, smart cards suffer from many of the same issues. They must be issued, distributed, carried, and then used only in POS terminals and other specially designated hardware devices. For example, MasterCard Chip Authentication Program (CAP) token readers.

In order to deal will these shortcomings, Cryptomathic (UK) developed a virtual chipcard for generating digital signatures, e.g., for signing documents with legal value at the exclusive instruction of the user. The object was to have electronic signatures available on a remote service, never routinely reveal those signatures outside a secure area in the Cloud. Such signatures are based on strong authentication of the user and/or their security token.

Client-side identification and authentication cards have improved internet banking application security. But if an account holder's computer is infected with malware, the keyboard and display screen communication between the user and the application can be overridden. Man-in-the-browser malware can modify transactions and go completely unnoticed by the user.

In another variation on security, an online banking service in Belgium, Dexia Direct Net, relies on a standalone, unconnected smart card readers equipped with a numeric keypad and a screen called Digipass. In order to complete a transaction, each user is asked to sign the transaction with their Digipass by inserting their bank card and entering their PIN code.

Deutsche Bank has an online banking service that requires the use of a Codecard associated to the user, and that is identified by a serial number. An array of codes is displayed on its surface. Users must login with a password and the Codecard to identify themselves to a website. The passwords are verified by the website. When a user confirms a transaction using the service, the website asks the user for one of the forty possible codes displayed on the Codecard. Unfortunately, all such transactions are subject to man-in-the-browser attacks.

The general failings in all the proposed schemes now circulating is that they cannot be employed immediately with existing mobile devices typically in the hands of users worldwide. Just about all of these require some hardware component to be bought, installed, or included for the mobile payment scheme to function. Several large technology and banking interests would like to capture the whole mobile payments market, but the solutions they offer usually just park their users in small market segments.

What is needed is a mobile payments system that can bestow the benefits of chip card user authentication on consumers equipped with only common mobile devices that they use routinely in their daily lives.

### SUMMARY

In certain embodiments, a secure payment system provisions a payment transaction proxy with virtual EMV-type chipcards on secure backend servers. Users authorize the proxy in each transaction to make payments in the Cloud for them. The proxy carries out the job without exposing the cryptographic keys to risk. User, message, and/or device authentication in multifactor configurations are erected in realtime to validate each user's intent to permit the proxy to sign for a particular transaction on the user's behalf. Users are led through a series of steps by the proxy to validate their authenticity and intent, sometimes incrementally involving additional user devices and communications channels that were pre-registered. Authentication risk can be scored by the proxy, and high risk transactions that are identified are tasked by further incrementally involving additional user devices, communications channels, and user challenges to increase the number of security factors used to authenticate.

In certain embodiments, a transaction proxy server is provided which is operatively coupled to the internet for authenticating authorization messages purporting to authorize transactions. The server comprises a memory device comprising cryptographic keys and a plurality of unique identifier datasets corresponding to a plurality of pre-registered user devices. The server further comprises a plurality of user device communication channels operatively coupled via the internet to the plurality of pre-registered user devices. The plurality of user device communication channels is configured to receive authorization messages from the plurality of pre-registered user devices, configured to transmit challenges to at least one user device of the plurality of pre-registered user devices, and configured to receive responses from the at least one user device. The server further comprises a processor communication channel operatively coupled to the internet and configured to transmit transaction signals to a transaction processor. The server further comprises at least one processor operatively coupled to the plurality of user device communication channels and the processor communication channel. The at least one processor is responsive to an authorization message, corresponding to a transaction and received from a user device of a user, by determining whether the user device is one of the plurality of pre-registered user devices. The at least one processor is responsive to the user device being one of the plurality of pre-registered user devices by determining whether the transaction warrants additional authorization. The at least one processor is responsive to the transaction warranting additional authorization by transmitting one or more challenges to one or more user devices of the user that are among the plurality of pre-registered user devices and receiving one or more responses from the one or more user devices of the user. The at least one processor is further configured to compare the one or more responses to information derived from one or more unique identifier datasets corresponding to the one or more user devices of the user. The at least one processor is responsive to a successful match of the one or more responses to the information by computing cryptographic information using the cryptographic keys and generating a transaction signal to be transmitted to the transaction processor. The transaction signal includes the cryptographic information and is indicative of approval of the transaction for completion.

In certain embodiments a method of operating a transaction proxy server to authenticate authorization messages purporting to authorize transactions for completion is provided. The server comprises a memory device comprising cryptographic keys and a plurality of unique identifier datasets corresponding to a plurality of pre-registered user devices. The method comprises receiving an authorization message from a user device of a user. The authorization signal corresponds to a transaction. The method further comprises determining whether the user device is one of the plurality of pre-registered user devices. The method further comprises, in response to determining that the user device is one of the plurality of pre-registered user devices, determining whether the transaction warrants additional authorization. The method further comprises, in response to determining that the transaction warrants additional authorization, transmitting one or more challenges to one or more user devices of the user that are among the plurality of pre-registered user devices and receiving one or more responses from the one or more user devices of the user. The method further comprises comparing the one or more responses to information derived from one or more unique identifier datasets corresponding to the one or more user devices of the user. The method further comprises, in response to a successful match of the one or more responses to the information, computing cryptographic information using the cryptographic keys and generating a transaction signal including the cryptographic information and indicative of approval of the transaction for completion.

These and other objects and advantages of certain embodiments described herein will no doubt become obvious to those of ordinary skill in the art after having read the following detailed description of the various embodiments that are illustrated in the various drawing figures.

### BRIEF DESCRIPTION OF THE DRAWINGS

FIG. 1A is a functional block diagram view of an example registration system useful in one part of an example virtual chipcard secure payment system in accordance with certain embodiments described herein;

FIG. 1B is a functional block diagram view of an example transaction system useful in a second part of the example virtual chipcard secure payment system of FIG. 1A;

FIG. 2 is a functional block diagram view of an example virtual chipcard secure payment system in accordance with certain embodiments described herein that relies on a personalization data service mechanism to provision a payment transaction proxy server in the Internet Cloud with virtual EMV-type chipcards;

FIG. 3 is a flow diagram of an example method 250 of operating a transaction proxy server to authenticate authorization messages purporting to authorize transactions for completion in accordance with certain embodiments described herein.

FIG. 4 is a flowchart diagram representing an example scenario compatible with certain embodiments described herein in which a shopper uses their smart connected computing device to make a purchase at a merchant's POS terminal;

FIG. 5 is a flowchart diagram representing another example scenario compatible with certain embodiments described herein in which a shopper uses more than one of their smart connected computing devices to make a purchase remote from a merchant's POS terminal or to engage in a transaction with a peer;

FIG. 6 is a flowchart diagram representing another example scenario compatible with certain embodiments described herein in which a shopper has only one of their smart connected computing devices on hand, and uses it to make a purchase remote from a merchant's POS terminal or to engage in a transaction with a peer; and

FIG. 7 is a flowchart diagram representing an example, compatible with certain embodiments described herein, of how requests for transactions are forwarded by user devices to a virtual chip card service, such as can be implemented with a secure server like is shown in FIGS. 1A-1B.

### DETAILED DESCRIPTION

Reference throughout this specification to “certain embodiments” or “an embodiment” means that a particular feature, structure, or characteristic described in connection with the embodiment is included in at least one embodiment of claimed subject matter. Thus, the appearances of the phrase “in certain embodiments” or “an embodiment” in various places throughout this specification are not necessarily all referring to the same embodiment. Furthermore, the particular features, structures, or characteristics disclosed to be in certain embodiments may be combined with the particular features, structures, or characteristics disclosed to be in other certain embodiments, in whole or in part. The scope of subject matter disclosed herein extends beyond the specifically disclosed embodiments to other alternative embodiments and/or uses, and to modifications and equivalents thereof. Thus, the scope of the subject matter disclosed herein is not limited by any of the particular embodiments described below. In addition, in any method or process disclosed herein, the acts or operations of the method or process may be performed in any suitable sequence and are not necessarily limited to any particular disclosed sequence.

In general, certain embodiments described herein provide users with secure access to their payment card accounts, identification, and various kinds of restricted control mechanisms for physical and electronic property. The secure applications, secret personalization data, and unique identifiers used in authentication are never actually in the hands of any user. The authorization data and computational services are instead maintained as virtual assets in the Cloud behind tamper resistant boundaries, e.g., as specified by Federal Institute of Processing Standards (FIPS) 140-2 Level 3+, also, Common Criteria Evaluation Assurance Level (CC EAL 4+). These protected applications are used to produce secure computation outputs that are derived from pre-registered personalized security parameters and depend on the inputs currently provided by the professed registered user.

In certain embodiments, conventional user devices like cellphones, smartphones, tablets, PC's, and other mobile electronics can be inventoried over a network with their unique identifiers on a registration server (e.g., a transaction proxy server configured to perform registration of the user devices). These user devices can be relied on during secure transaction requests (e.g., authorization messages) to be able to communicate between secure servers and each user over multiple independent and concurrent communications channels (for example, the mobile telephone networks, email, SMS text, Internet, 4G packet service, etc.). In certain embodiments, each additional device, and each additional communications channel that can be involved in a secure transaction can be employed to incrementally raise the authentication confidence levels for the transaction by adding another, independent security factor.

The authentication of a device or an authorization message transmitted from the device can include recognizing and/or validating a given user's device by relying on pre-established, identifiers unique to the device that were surveyed during registration. If possible, the individual natures of these unique identifiers are such that they cannot be copied or spoofed, e.g., as in an identification protocol such as challenge response-based queries to special purpose hardware on a device that has been individually personalized using cryptographic keys.

Some embodiments described herein include one or more processors which are configured to score user, device, and message authentication confidence levels, and such processors can be configured to summon additional security factor inputs if the nature of the present transaction is such that the user or the transaction proxy server providing the secure application hosting services determines that stronger levels of authentication are appropriate.

Conventional financial transactions typically use a single channel of communication that is one-way from the user's payment card to the point of sale (POS) terminal, and on to the payment server. Smart payment cards, in the hands of the users themselves, will compute a cryptogram and output it for the POS terminal if the user at a minimum has input a correct password. A simple message that the transaction has been approved is usually the only thing returned to the POS terminal At best, the user will get a paper receipt showing the details of the transaction as the POS terminal best understands it. The payment server may have a different record if the communications channel has been compromised and the user account was assaulted during or after the transaction.

A configuration utilizing handshake signaling end-to-end between the user and the payment server can allow both ends of the transaction to understand what the other intends to be the main parameters of the transaction, e.g., the transaction value and merchant involved. Certain embodiments described herein deploy a user transaction proxy server on the Internet Cloud that authenticates the users or messages with two-channel handshakes involving passwords, confirmations, and even cryptographic calculations. Crypto-encoded credentials or keys issued by a bank, for example, can be stored in the Internet Cloud in the user transaction proxy server and can be provided privately to the payment processor after user verification. The actual credentials or keys are generally not exposed to the users or the POS terminals they patronize. Some exposure may be used by particular payment schemes in order to compete a transaction.

Each typical user can have several mobile devices they employ in their daily lives. Each of these mobile user devices can be supported by a variety of communications service providers, e.g., high speed Internet service, telephone, wireless mobile, email, and 4G packet networks, or even fax. Each of these mobile user devices can be strongly associated with corresponding IP-addresses, email addresses, SIM cards, electronic serial number (ESN), international mobile equipment indicator (IMEI), subscriber phone numbers, etc., and each mobile user device can support a message delivered to a single destination and can utilize multiple communication channels, either concurrently or consecutively.

For example, a typical smartphone can log onto a webpage and receive emails simultaneously, e.g., by using two different communications channels and respective application programs. In certain embodiments described herein, any of the communications channels and devices employed can be available for contemporaneous, concurrent, or simultaneous use. The users' venues can change transaction-by-transaction, so knowledge regarding the current device environment can be helpful so unavailable channels and devices can be predicted and no effort will be wasted on them. For example, at home or in their office, a user's fax machine could be a viable device using a hardwired fax line for the communications channel. But in a merchant's store, the fax line would not be an option. However, the merchant's POS terminal could be employed as a device and channel between the user and the transaction proxy server.

In general, modern mobile, personal trusted devices can be strongly authenticated using uniquely identifiable functionality embedded within their circuitry. At the same time, non-protected and non-isolated memory space in such devices makes them all too vulnerable to attacks aimed at stealing any cryptographic keys that may be present. It is understandable then a new system and method is desired that does not park cryptographic keys on such devices so that there would be nothing to steal from the mobile devices.

3-D Secure is an XML-based protocol used as an added layer of security for online credit and debit card transactions. Visa uses it to improve the security of Internet payments and offered it to customers as the Verified by Visa service. XML messages are sent over secure socket layer (SSL) connections with client authentication that uses digital certificates to ensure the authenticity of both peers, the server and the client. Transactions initiate a redirect to a website operated by the card issuing bank to authorize the transaction.

Typically a password-based authentication method is used, so purchases on the Internet use passwords tied to the card. Similar services based on the protocol have also been adopted by MasterCard, e.g., SecureCode, and by Japan Credit Bureau (JCB) International as J/Secure. American Express has SafeKey in the UK and Singapore.

What is desired is a way to create a strong binding between users and the peculiar combination of devices they own and the associated authentication services they subscribe to. That combination reduces to one user only who can establish access to the keys in another secure service without having to hold or reveal the keys themselves to authorize payment. In addition, a secure backend payment server (e.g., a transaction proxy server) can be triggered to produce the same output as would have been produced by the user had they used a payment chip card. The keys therefore never have to leave the backend server.

In a virtual payment chipcard service for secure payments in accordance with certain embodiments described herein, a transaction proxy server can be operatively coupled to the internet for authenticating authorization messages purporting to authorize transactions. A chip-card calculation can be emulated on a secure back-end (e.g., by the transaction proxy server as described herein) to allow users to pay in the Cloud without the risk of compromising their cryptographic keys. Strong authentication of the user and/or the message to be signed can be used in validating the user's intent. In certain such embodiments, the system can serve as a means for the user to effectively allow a proxy (e.g., the transaction proxy server) to sign the transaction on their behalf. Device authentication of the user's pre-registered devices can also be used as a means to validate the user's intent. The transaction proxy server can be configured to generate an individual digital signature on a particular message authorized by a user at the user's request with the user's individual private key stored in a secure environment.

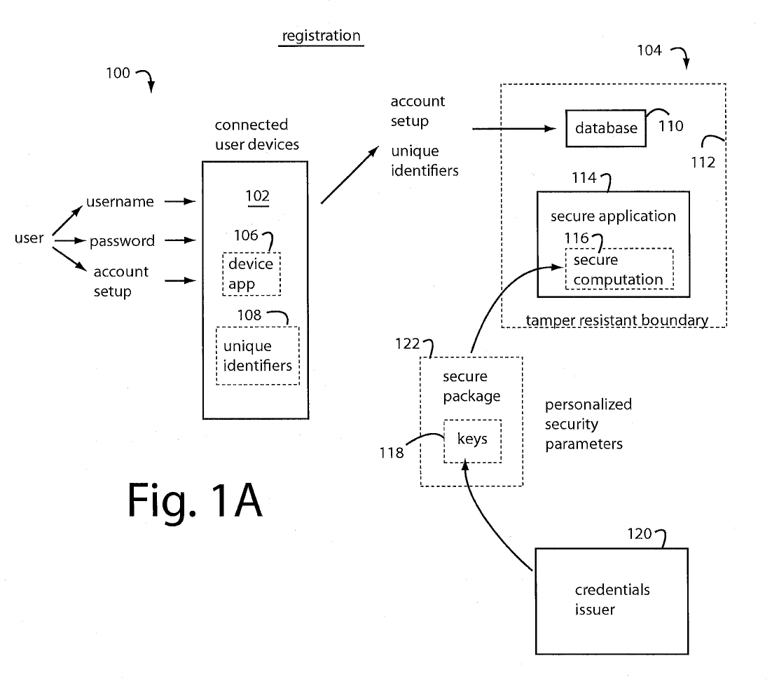

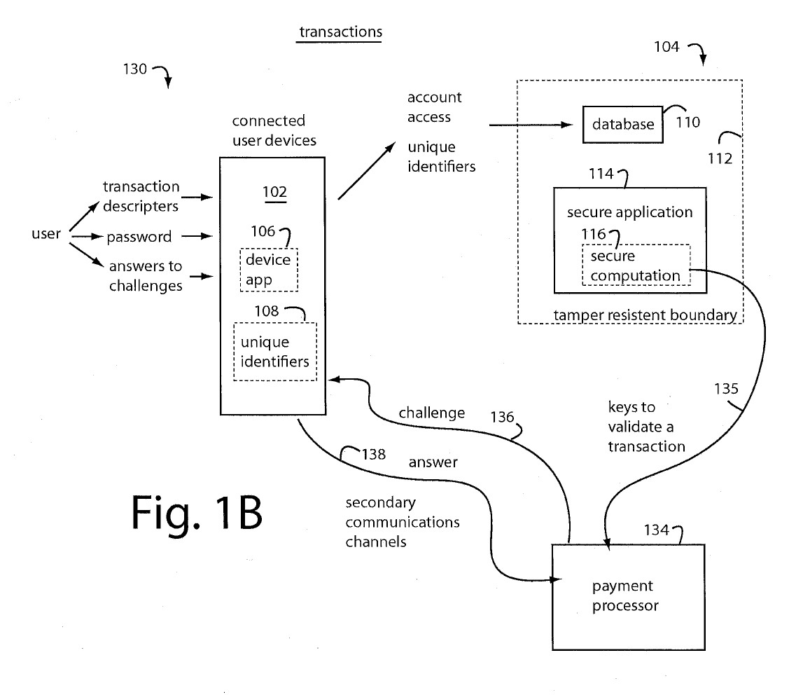

FIG. 1A represents an example registration system 100 useful in one part of an example virtual chipcard secure payment system in accordance with certain embodiments described herein. The registration system 100 provides for fixing an inventory of connected user devices 102 (e.g., a plurality of pre-registered user devices) that can thereafter be used as authorized devices in user transactions with a secure server 104 (e.g., the transaction proxy server). In addition, the registration system 100 provides a plurality of unique identifier datasets (e.g., virtual chipcards) corresponding to the plurality of pre-registered user devices. A device app 106 can be installed or downloaded in one of more of the connected user devices 102 and can provide a graphical user interface to control and guide a user through device registration and user transactions. Each connected user device 102 will naturally have unique identifiers 108 associated with it that can be used later in device or message authentication for a user transaction. These datasets of unique identifiers 108 can be automatically explored, securely packaged, and forwarded by the device app 106 to a database 110 of the received unique identifier datasets. This database 110 of a plurality of unique identifier datasets corresponding to the plurality of pre-registered user devices can be stored in memory (e.g., on a memory device) of the transaction proxy server disposed within (e.g., behind) a tamper resistant boundary 112 in the secure server 104 (e.g., the transaction proxy server).

A secure application 114 can be included in a safe location in the Cloud (e.g., behind the tamper resistant boundary 112 in the transaction proxy server) to execute secure computations 116 using keys and algorithms 118 (e.g., cryptographic keys and algorithms) provided by a credentials issuer 120 (e.g., inside a secure package 122), and which can be subsequently stored in the memory (e.g., on a memory device) of the transaction proxy server. In this way, the transaction proxy server can be configured to receive securely transmitted personalization data from a credentials issuer 120 (e.g., an issuing bank) and can include the securely transmitted personalization data in the plurality of unique identifier datasets. Such safe locations are often referred to as hardware security modules (HSM's) which are a type of secure cryptoprocessor for managing digital keys, accelerating digital signings, and for providing strong authentication in server applications. HSM's can be built as plug-in cards or external TCP/IP security devices that can be attached directly to a server (e.g., the transaction proxy server) or general purpose computer. The cryptographic material handled by most HSM's are symmetric keys, and asymmetric key pairs and certificates used in public-key cryptography.

In certain embodiments, the transaction proxy server can be configured to receive encoded unique identifiers from a user device (e.g., from the device app 106 running on the user device) during the process of registering the user device to be a pre-registered user device of the plurality of pre-registered user devices. The transaction proxy server can also be configured to include the unique identifiers in the unique identifier dataset corresponding to the user device, to register the user device, and to include the user device in the plurality of pre-registered user devices. In certain embodiments, the authorization message received from the user device is encoded by the user device using the unique identifiers, and the transaction proxy server (e.g., at least one processor of the transaction proxy server) can be configured to decode the authorization message using the unique identifiers. In certain embodiments, as part of the registration process, the transaction proxy server can transmit one or more challenges to the user device being registered and can receive one or more responses to the one or more challenges from the user device. The transaction proxy server can then include the one or more responses in the unique identifier dataset corresponding to the user device. As described more fully below, information derived from the unique identifier dataset (e.g., information regarding the one or more responses) can be subsequently compared to one or more responses received by the transaction proxy server during an authorization process, and a successful match can increase the authorization confidence level for the authorization message being authenticated.

In an example payment card system compatible with certain embodiments described herein, each secure application 114 of the transaction proxy server can operate as the equivalent of an EMV chipcard disposed in a cryptographic smartcard, and the keys and algorithms 118 can represent the personalization data that would ordinarily be coded into such an EMV chipcard. In one example secure identity system compatible with certain embodiments described herein, the secure application 114 of the transaction proxy server can operate as the equivalent of a biometric template. A biometric sample can be collected by the connected user devices 102 and forwarded by the credentials issuer 120 to the secure server 104 for authentication by secure computation 116 using the biometric template in secure application 114. In another embodiment, users enter an appropriate identification protocol using one or several of their devices. In certain embodiments, the unique identifier datasets comprise EMV-type data, biometric-template data, or both. In certain embodiments in which the unique identifier datasets comprise EMV-type data, the transaction signal can comprise EMV-type data corresponding to the user device from which the authorization message was received and encoded using the cryptographic keys, and the transaction processor can comprise an EMV payment processor configured to decode and use the EMV-type data. In certain embodiments, transaction signals received by the transaction processor from the transaction proxy server are indistinguishable from transaction signals received by the transaction processor from a conventional EMV chipcard.

One object in providing such registration in a financial payment card system compatible with certain embodiments described herein is to associate users' mobile wallets with corresponding mobile and other connected devices while assuring that the payment application key space is appropriately protected.

Each new user device 102 that is to be bound thereafter to a user can utilize a secure communication of the device credentials to an authentication part of a secure virtual chip card service in secure application 114 of the transaction proxy server. Here, static device credentials or dynamic device credentials could be used effectively. Transport Layer Security (TLS) and its predecessor, Secure Sockets Layer (SSL), are protocols that provide communication security over the Internet. TLS and SSL encrypt the segments of network connections above the Transport Layer, using asymmetric cryptography for key exchange, symmetric encryption for privacy, and cryptographic one-way functions for message integrity. Secure Remote Password (SRP) is a password-based authentication and key exchange protocol for secure authentication of clients to servers.

FIG. 1B represents an example transaction system 130 useful in a virtual chipcard secure payment system, in accordance with certain embodiments described herein, for authenticating authorization messages purporting to authorize transactions, thereby securing user transactions with a form of virtual chip card maintained by a virtual chip card server (e.g., the transaction proxy server) operated in the “Cloud”. The virtual chip card server (e.g., the transaction proxy server) can be commissioned to securely compute cryptographic operations on behalf of each user if, and only if, evidence is presented that the particular user is who they claim to be, and that such user actually intends to carry out the transaction at hand. The cryptograms can be computed after being authorized and can then be transparently forwarded from the secure server 104 (e.g., the transaction proxy server), e.g., to a payment processor 134 without circuiting through the user devices. The technology described by the present inventors in U.S. Pat. No. 8,078,879, issued Dec. 13, 2011, which is incorporated in full by reference herein, can be used to provide good results in many embodiments described herein.

A transaction can be initiated by a user, a peer, or a merchant in a number of ways. For example, a user device can transmit an authorization message to the transaction proxy server, with the authorization message purporting to authorize a transaction on behalf of the user. However initiated, a password that was previously associated with device app 106 can be reentered by each user or a device function for comparison. The connected user devices 102 can encode a message (e.g., an authorization message) using such newly provided passwords, the unique identifiers 108, and other characterizing datapoints belonging to the device. Secure server 104 (e.g., the transaction proxy server) can decode these for user, device, and message authentications. If authenticated, cryptogram keys 135 can be computed using the personalization data registered and held for that user, and the results can be forwarded to the payment processor 134.

Besides being configured to receive authorization messages from the plurality of pre-registered user devices, the plurality of user device communication channels can be configured to transmit challenges to at least one user device of the plurality of pre-registered user devices and configured to receive responses from the at least one user device. During the process of authentication, one or more challenges 136 may be sent to a second one of the connected user devices 102 of the user and/or may be sent using a different communications channel, such as SMS text, email, voice call, Internet, or even a POS terminal. For example, the authorization message (e.g., a message corresponding to initiating a purchase of an airline ticket) can be transmitted by a first user device (e.g., a tablet) of the user and one or more challenges 136 (e.g., a pop-up message asking the user to validate) can be transmitted by the transaction proxy server to one or more second user devices (e.g., a smartphone) of the user that are different from the first user device. By responding to the one or more challenges 136 (e.g., by clicking “OK” on the smartphone), the user can instruct the transaction proxy server to authenticate the transaction initiated on the first user device.

For another example, the authorization message can be received from a user device communication channel and one or more challenges 136 can be transmitted via one or more other user device communication channels different from the user device communication channel from which the authorization message was received. Some or all of these one or more user device communication channels can be operatively coupled to the same user device of the user that transmitted the authorization message and some or all of these one or more user device communication channels can be operatively coupled to a different user device of the user. Some or all of these one or more user device communication channels can be operatively coupled to the same user device as one another.

In order for the proposed transaction to succeed, the users can respond to the one or more challenges 136 with their one or more answers 138 which will satisfy the one or more challenges 136 (e.g., match acceptable answers to these one or more challenges 136 that are stored or calculated in the database 110 of the transaction proxy server). Alternatively, a value may be computed on the device using inputs obtained by the device and/or user. The results can be forwarded to the transaction proxy server (or in certain embodiments to the payment processor 134), for comparison to values calculated from stored, registration inputs.

For the communication between the user device and the transaction proxy server (e.g., authorization messages, challenges, answers), public-key cryptography can be used in a cryptographic system utilizing two separate keys, one to lock or encrypt the plaintext, and one to unlock or decrypt the cyphertext. Neither key will do both functions. One of these keys can be public and the other can be kept private. Messages from the user devices can be encrypted for signature verification in the Cloud, e.g., by the authentication servers (e.g., one or more processors of the transaction proxy server). Cryptographic one-way functions can be used such as a calculation of a hash value of the message.

U.S. Pat. No. 7,725,723, issued May 25, 2010, incorporated in full by reference herein, describes signing electronic data with a digital signature for receipt by a signature server and an authentication server, which could be useful in implementing certain embodiments described herein. The signature server can provide secure parking in the Cloud for the users' private cryptographic keys. Each user can contact the servers (e.g., one or more processors of the transaction proxy server) through a secure channel. A password or other token can be furnished, based on information previously registered by the user. The authentication server can forward a derivative to the signature server for comparison with the one originally supplied by the user during registration. If there is a match, any message data received from the user can be authenticated to be signed with the user's private key.

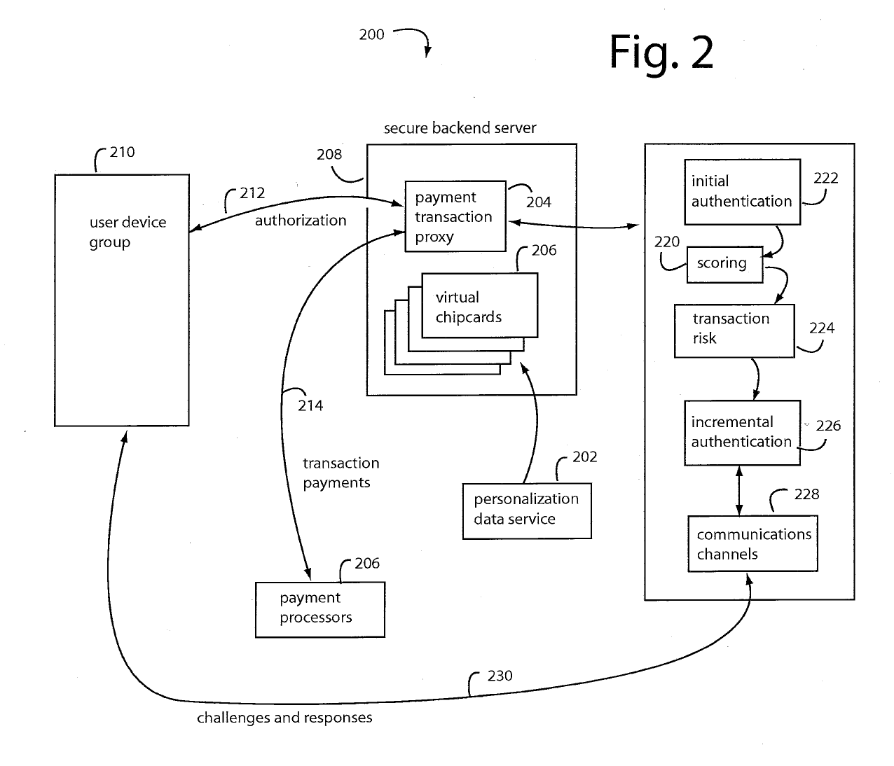

In FIG. 2, an example virtual chipcard secure payment system 200 in accordance with certain embodiments described herein. The system 200 can utilize a transaction proxy server (e.g., the secure backend server 208) comprising a memory device, a plurality of user device communication channels operatively coupled via the internet to the plurality of pre-registered user devices (e.g., the user device group 210), a processor communication channel operatively coupled to the internet, and at least one processor (e.g., at least one payment transaction proxy processor 204) operatively coupled to the plurality of user device communication channels and the processor communication channel. In certain embodiments, the system 200 utilizes a personalization data service mechanism 202 to provision the transaction proxy server with a plurality of unique identifier datasets (e.g., virtual EMV-type chipcards 206) corresponding to the plurality of pre-registered user devices and stored on the memory device of the transaction proxy server (e.g., the secure backend server 208) all in the Internet Cloud. The user device group 210 (e.g., the plurality of pre-registered user devices) in the hands of their respective users can be equipped to transmit authorization messages 212 to the at least one processor 204 via the plurality of user device communication channels of the transaction proxy server. The at least one processor (e.g., the at least one payment transaction proxy processor 204) can make transaction payments 214 for the user devices by transmitting transaction signals, via the processor communication channel, to a transaction processor (e.g., the payment processor 216). The payment processor 216 can accept the transaction signals from the at least one payment transaction proxy processor 204 as it would a typical user engaged in an EMV-type smartcard transaction. The at least one payment transaction proxy processor 204 and the processor communication channel can be configured to carry out each job without exposing the cryptographic keys in its plurality of unique identifier datasets (e.g., virtual chipcards 206) to risk of disclosure to a third party.

The at least one payment transaction proxy processor 204 can include a processor for erecting user, message, and/or device authentications in multifactor configurations in realtime to validate and confirm each user's intent to permit the payment transaction proxy server to sign for a particular transaction on a user's behalf. For example, in certain embodiments, the user can be asked to state or accept an amount of the transaction and the users' intent can be implied by their entering or acknowledging the transaction amount in a message as part of an identification protocol.

The at least one payment transaction proxy processor 204 can also include a processor for leading users through a series of challenges or steps to validate the user's authenticity and intent. This process of transmitting challenges and receiving answers can result in additional user devices and communications channels belonging to particular user device groups 210 of the plurality of pre-registered user devices being incrementally involved to strengthen an initial authentication. Each user can communicate with the at least one payment transaction proxy processor 204 through a pre-registration process using their own unique collection of network-connectable computing devices.

In certain embodiments, the at least one payment transaction proxy processor 204 of the secure payment system 200 can be configured to determine whether the transaction to be authorized warrants additional authorization. For example, the at least one payment transaction proxy processor 204 can estimate the risk in an initial authentication process 222 by scoring 220 the transaction for risk as can be determined from the first few authentication factors (e.g., an amount of the transaction, a location of the transaction, a type of the transaction) originally accepted by the payment transaction proxy 204. A transaction risk process 224 can utilize the scoring for identifying high risk transactions that would benefit from using the highest confidence in the on-going authentication of the user, their involved devices, and the messages.

The at least one payment transaction proxy processor 204 can perform an additional authentication process 226 which comprises incrementally utilizing more user devices from device group 210 (e.g., the plurality of pre-registered user devices), more communications channels 228 (e.g., one or more of the user device communication channels), or a combination of more user devices and more communication channels. For example, the at least one payment transaction proxy processor 204 can iteratively determine whether the transaction to be authorized warrants additional authorization, transmits one or more additional challenges, receives one or more additional responses, and compares the one or more additional responses to the information derived from the one or more unique identifier datasets corresponding to the user devices. These iterations can be performed until the scoring 220 and transaction risk process 224 indicate that a predetermined authentication confidence level has been reached. Thus, in certain embodiments, the at least one payment transaction proxy processor 204 can add user challenges and/or responses 230 to increase the number of security factors to be fulfilled in authenticating a particular high risk transaction. These additional measures can add more what-you-know and what-you-have type security factors. Some of these devices, channels, and messages may be able to add where-you-are and what-you-intend security factors for maximally strong, multi-factor authentication.

As described in connection with FIG. 1A, in certain embodiments, a pre-registration process 100 encodes and forwards unique identifiers 108 detectable in each of the network-connectable computing devices 102 (e.g., the pre-registered user devices), which are stored as the unique identifier datasets corresponding to the plurality of pre-registered user devices, and such unique identifier datasets are thereafter useable in the initial authentication process 222 and in the incremental authentication process 226 (FIG. 2) in support of a payment transaction 214. The pre-registration process 100 may additionally encode and forward user answers to stock challenges stored in the database 110 (e.g., stored in memory of the transaction proxy server). The answers that users give during the authentication of a later authorization message corresponding to a later transaction to be authorized can be compared to the ones stored, and are thereby able to support user-authentication undertakings. Alternatively, the pre-registration process 100 may store security parameters that enable the secure package 122 to calculate values and compare them to values 230 forwarded using the same parameters available to the users and/or their devices. The initial authentication process 222 or the incremental authentication process 226 can include a process for having the user state or accept the amount of the transaction at hand.

The client-side software for execution on at least some of the mobile user devices 210 can be collectively implemented in-part with apps for mobile operating systems similar to Apple iOS and Google Android. The personalization data service 202 can provision the at least one payment transaction proxy processor 204 with virtual EMV-type chipcards 206 on the secure backend server 208 (e.g., the transaction payment server) and can include a secure transmission 122 (FIG. 1A) of personalization data 118 from an issuing bank 120.

In certain embodiments, as described herein, the at least one processor (e.g. the at least one payment transaction proxy processor 204) is responsive to the authorization message, which corresponds to the transaction to be authorized and which is received from a user device of the user, by determining whether the user device is one of the plurality of pre-registered user devices. The at least one processor can respond to the user device being one of the plurality of pre-registered user devices by determining whether the transaction warrants additional authorization. The at least one processor can respond to the user device not being among the plurality of pre-registered user devices by not generating the transaction signal.

In certain embodiments, the at least one processor can respond to the transaction warranting additional authorization by transmitting one or more challenges to one or more user devices of the user that are among the plurality of pre-registered user devices and receiving one or more responses from the one or more user devices of the user. The at least one processor can respond to the transaction now warranting additional authorization by computing the cryptographic information using the cryptographic keys and generating the transaction signal to be transmitted to the transaction processor. The transaction signal can include the cryptographic information and can be indicative of approval of the transaction for completion.

In certain embodiments, the at least one processor can compare the one or more responses to information derived from one or more unique identifier datasets corresponding to the one or more user devices of the user. The at least one processor can respond to a successful match of the one or more responses to the information by computing cryptographic information using the cryptographic keys and generating a transaction signal to be transmitted to the transaction processor. The transaction signal can include the cryptographic information and can be indicative of approval of the transaction for completion. The at least one processor can respond to an unsuccessful match of the one or more responses to the information by not generating the transaction signal. As used herein, the phrase “successful match” has its broadest reasonable interpretation, including but not limited to, a comparison of the one or more responses to the information that indicates that the responses correspond to the information, and the phrase “unsuccessful match” has its broadest reasonable interpretation, including but not limited to, a comparison of the one or more responses to the information that indicates that the responses do not correspond to the information. For example, a successful match can include having the responses be identical to the information, or having the responses be substantially identical to the information, and an unsuccessful match can include having the responses be different from the information, or having the responses less than substantially identical to the information.

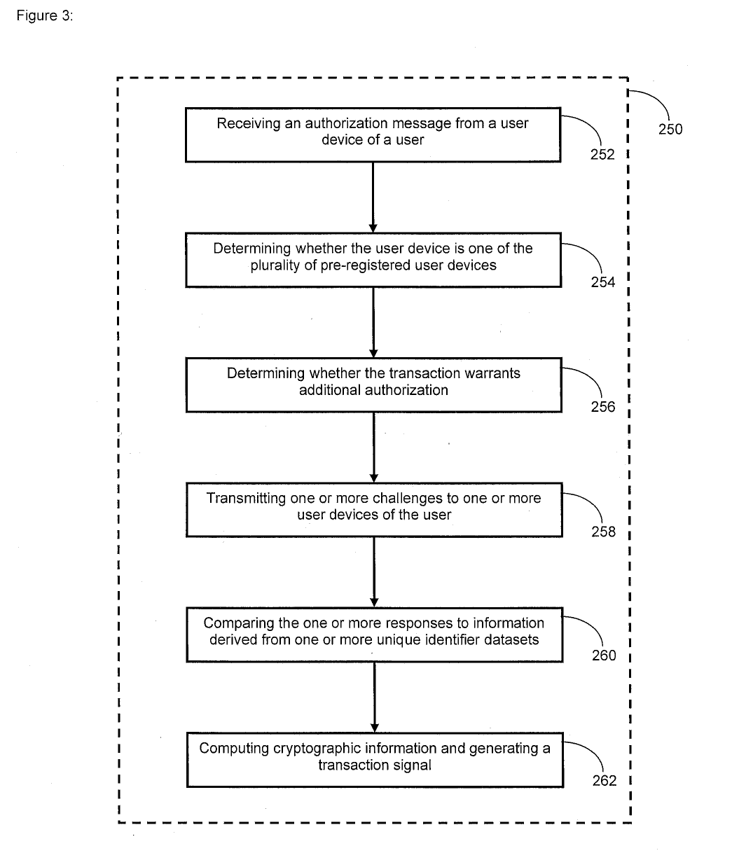

FIG. 3 is a flow diagram of an example method 250 of operating a transaction proxy server to authenticate authorization messages purporting to authorize transactions for completion in accordance with certain embodiments described herein. As described herein, the server can comprise a memory device comprising cryptographic keys and a plurality of unique identifier datasets corresponding to a plurality of pre-registered user device. In an operational block 252, the method 250 comprises receiving an authorization message from a user device of a user. The authorization signal corresponds to a transaction. In an operational block 254, the method further comprises determining whether the user device is one of the plurality of pre-registered user devices. In an operational block 256, the method 250 further comprises in response to determining that the user device is one of the plurality of pre-registered user devices, determining whether the transaction warrants additional authorization. In an operational block 258, the method 250 further comprises, in response to determining that the transaction warrants additional authorization, transmitting one or more challenges to one or more user devices of the user that are among the plurality of pre-registered user devices and receiving one or more responses from the one or more user devices of the user. In an operational block 260, the method further comprises comparing the one or more responses to information derived from one or more unique identifier datasets corresponding to the one or more user devices of the user. In an operational block 262, the method 250 further comprises, in response to a successful match of the one or more responses to the information, computing cryptographic information using the cryptographic keys and generating a transaction signal including the cryptographic information and indicative of approval of the transaction for completion.

In certain embodiments, the method 250 further comprises sending the transaction signal to a transaction processor. In certain embodiments, the method 250 further comprises receiving encoded unique identifiers from at least one user device to be registered as at least one pre-registered user device of the plurality of pre-registered user devices, including the unique identifiers in at least one unique identifier database corresponding to the at least one user device, and registering the at least one user device and including the at least one user device in the plurality of pre-registered user devices. In certain embodiments, the method 250 further comprises transmitting one or more challenges to the at least one user device to be registered, receiving one or more responses to the one or more challenges from the at least one user device, and including the one or more responses in the at least one unique identifier dataset corresponding to the at least one user device. In certain embodiments, the method 250 comprises iteratively performing said determining whether the transaction warrants additional authorization, said transmitting one or more challenges, said receiving one or more responses, and said comparing until a predetermined authentication confidence level is reached.

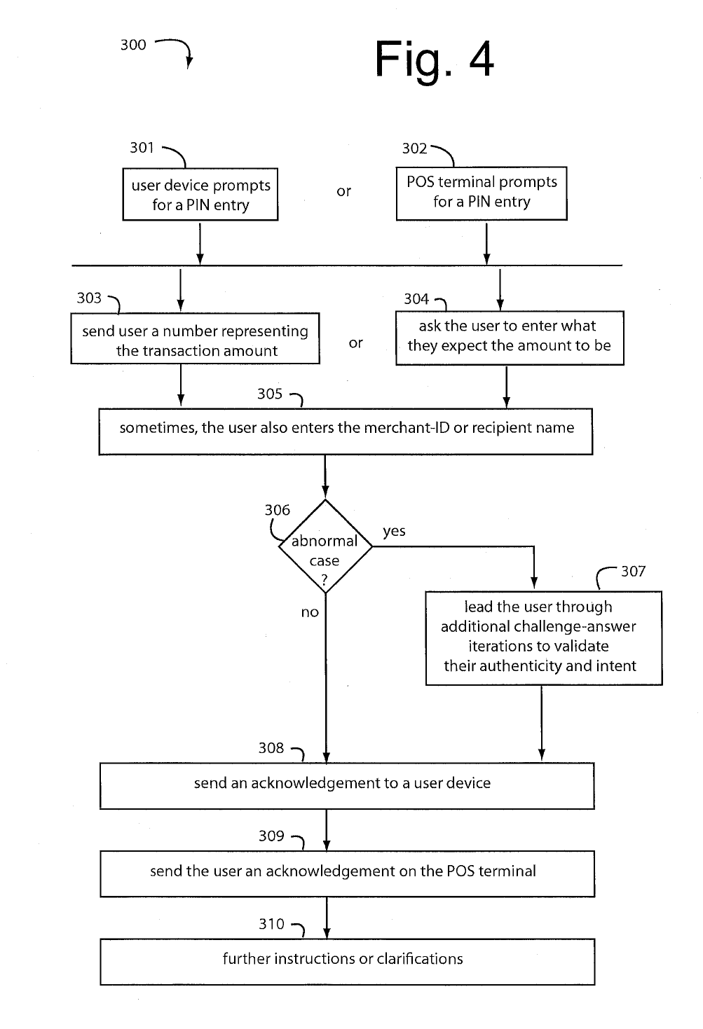

FIG. 4 represents an example scenario 300 compatible with certain embodiments described herein in which a shopper (e.g., a user) uses their smart connected computing user device, e.g., a phone, tablet, or PC, to make a purchase at a merchant's point of sale terminal (POS). Such smart connected computing device can have at least two independent channels of communication, such as the Web, email, SMS, voice, etc. These independent channels can help later in negotiating higher levels of authentication of the user, the device, and the purchase request message. In a step 301, the user device prompts the user for a PIN entry. Alternatively, in a step 302, the POS terminal instead prompts the user for a PIN entry. In response to receiving an authorization message corresponding to the transaction, the payment system (e.g., a processor of the transaction proxy server) sends the user device a number in step 303 indicating the money amount involved in the transaction. Or, in step 304 the user types in the amount of the transaction to be approved. In some cases, the user also enters the merchant-ID or recipient name in a step 305. The user can therefore confirm or reject the proposed transaction. The transaction proxy server can compare the responses received from the user device to information derived from a unique identifier datasets corresponding to the user device.

In situations where the confidence in the authentication is marginal for some reason, or the amounts of the transaction are unusually high, or the place of the transaction is odd, or the kind of transaction is out of character, or other abnormal cases, a decision 306 is made (e.g., by a processor of the transaction proxy server) to lead the user in a step 307 through additional challenge-answer-comparison iterations to validate their authenticity and intent. These additional authentication iterations can be conducted across one or more communication channels that are the same or different from the communication channel over which the authorization message was transmitted to the transaction proxy server, such as by phone call, SMS text, email, website, and/or by way of another device also registered to this user. In a step 308, upon a successful match of the one or more responses to the information derived from the unique identifier dataset corresponding to the user device, the transaction proxy server can compute cryptographic information and generate a transaction signal indicative of approval of the transaction for completion (e.g., to the payment processor). The transaction proxy server can also transmit to the user an electronic acknowledgement through an appropriate channel on one of their devices. Or, in a step 309, the user receives an electronic acknowledgement on the POS terminal. In certain embodiments, a step 310 electronically sends further instructions for the user to do something more or to clarify an ambiguity.

In certain embodiments, the processor of the transaction proxy server can be provided with guidelines or other information to be used in evaluating whether the transaction warrants additional challenge-answer-comparison iterations in the decision 306 to authenticate the authorization message. For example, in configurations in which the unique identifier datasets comprise EMV-type data, these guidelines can be determined by the bank responsible for executing the transaction. The guidelines can distinguish groups, types, or categories of transactions from one another, based on one or more criteria, including but not limited to: the transaction amount, the geographic location in which the transaction is to occur, the quality of protection provided by the user device, and the historically normal transaction behavior of the user. These criteria are described in further detail below. The guidelines can also stipulate the number of tokens to be used to authenticate an authorization message based on the level of security that is to be provided and the quality of the tokens that are available for use, as described in further detail below.

In certain embodiments, the guidelines can distinguish between transactions based on the amount of the transaction. For example, the guidelines can distinguish among transactions having an amount of $50 or less (e.g., category 1), transactions having an amount greater than $50 and less than $250 (e.g., category 2), and transactions having an amount greater than $250 (e.g., category 3). The guidelines can stipulate that: for transactions in category 1, only a single challenge-answer-comparison is to be performed; for transactions in category 2, more than one challenge-answer-comparison is to be performed; and for transactions in category 3, more than two challenge-answer-comparisons are to be performed. Upon each of the performed challenge-answer-comparisons yielding a successful match, the processor can proceed to authenticate the transaction.

In certain embodiments, the guidelines can distinguish among user devices with different quality of protection. For example, the guidelines can distinguish among user devices that provide a low quality of protection (e.g., user devices that are only software-protected, user devices that provide low-quality tokens), user devices that provide a medium quality of protection (e.g., user devices that are smartphones, user devices that provide medium-quality tokens), and user devices that provide a high quality of protection (e.g., user devices that are smartphones that include a separate chip for user authorization, user devices that provide high-quality tokens). The guidelines can stipulate that for a user device having a lower quality of protection, more challenge-answer-comparisons are performed, as compared to a user device having a higher quality of protection, in authenticating the authorization message.

For example, Tables 1 and 2 show two example sets of guidelines for the number of user devices used for authenticating an authorization message based on the number of user devices available for such use and the quality of protection provided by each of the available user devices. As shown in Table 1, if only one user device is available for authentication, and this one user device provides a low quality of protection, then the guidelines can stipulate that the transaction is not allowed (e.g., the authorization message is not authenticated). If two or three user devices are available for authentication, and each of these user devices provides a low quality of protection, then the guidelines can stipulate that two user devices are used for the authentication. If one, two, or three user devices are available, and each of these user devices provides a medium quality of protection or a high quality of protection, then the guidelines can stipulate that one user device is used for the authentication.

TABLE 1

| | Low | Medium | High |
|---|---|---|---|
| Number of available | Protection | Protection | Protection |
| user devices | Quality | Quality | Quality |
| One | Not allowed | 1 | 1 |
| Two | 2 | 1 | 1 |
| Three | 2 | 1 | 1 |

Table 2 shows an example set of guidelines that are stricter than the example set of guidelines shown in Table 1. As shown in Table 2, if one or two user devices are available for authentication, and these user devices provide a low quality of protection, then the guidelines can stipulate that the transaction is not allowed (e.g., the authorization message is not authenticated). If one user device is available for authentication, and this user device provides a medium quality of protection, then the guidelines can stipulate that the transaction is not allowed (e.g., the authorization message is not authenticated). If three user devices are available for authentication, and each of these user devices provides a low quality of protection, then the guidelines can stipulate that all three user devices are used for the authentication. If two or three user devices are available for authentication, and each of these user devices provides a medium quality of protection, then the guidelines can stipulate that two user devices are used for the authentication. If one, two, or three user devices are available, and each of these user devices provides a high quality of protection, then the guidelines can stipulate that one user device is used for the authentication.

TABLE 2

| | Low | Medium | High |
|---|---|---|---|
| Number of available | Protection | Protection | Protection |
| user devices | Quality | Quality | Quality |
| One | Not allowed | Not allowed | 1 |
| Two | Not allowed | 2 | 1 |
| Three | 3 | 2 | 1 |

In certain embodiments in which only one user device is available for authentication (e.g., in the examples of Tables 1 and 2), if the user device provides a sufficient quality of protection, one user device communication channel of the user device can be used to transmit an initial authorization message to the transaction proxy server and another one or more user device communication channels of the user device can be used to transmit challenges to the user device and to transmit responses from the user device. For example, if the user is traveling and only has one user device available for authorizing a transaction (e.g., a smartphone), the user can attempt to initiate a transaction using one app or one webpage on the user device which transmits an initial authorization message to the transaction proxy server, and the challenges and responses of the authentication process can be transmitted via a different app (e.g., a pre-registered app) on the user device.

In certain embodiments, the guidelines can distinguish among transactions that are to occur within a predetermined geographic region and transactions that are to occur outside the predetermined geographic region. Examples can include having the guidelines distinguish among transactions that are to occur within or outside the user's state of residence, within or outside the user's country of residence, and/or within or outside predetermined countries identified as having a higher probability of fraudulent transactions.

In certain embodiments, the guidelines can be generated using artificial intelligence which monitors a user's transaction behavior to determine one or more characteristics indicative of the user's historically normal transaction behavior and distinguishes among transactions that are within the user's historically normal transaction behavior and transactions that are outside the user's historically normal transaction behavior.

In certain embodiments, the guidelines can stipulate the number of tokens to be used to authenticate an authorization message based on the level of security that is to be provided and the quality of the tokens that are available for use. Table 3 shows an example set of guidelines for the number of tokens used for authenticating an authorization message based on the level of security that is to be provided and the quality of the tokens that are available for use. As shown in Table 3, if a high level of security is to be provided and only low-quality tokens are available for authentication, then the guidelines can stipulate that the transaction is not allowed (e.g., the authorization message is not authenticated). If a medium level of security is to be provided and only low-quality tokens are available for authentication, then the guidelines can stipulate that two low-quality tokens are to be used in authenticating the authorization message. If a low level of security is to be provided and only low-quality tokens are available for authentication, then the guidelines can stipulate that one low-quality token is to be used in authenticating the authorization message. If the available tokens are medium-quality tokens, then the guidelines can stipulate that two tokens are to be used for a high level of security, one token is to be used for a medium level of security, and one token is to be used for a low level of security for authenticating the authorization message. If the available tokens are high-quality tokens, then the guidelines can stipulate that one token is to be used for a high level of security, a medium level of security, or a low level of security. The at least one processor of the transaction proxy server can determine which level of security is to be provided for a transaction based on the group, type, or category of the transaction (e.g., based on the transaction amount, the geographic location in which the transaction is to occur, and the historically normal transaction behavior of the user).

TABLE 3

| | High | Medium | Low |
|---|---|---|---|
| | Security | Security | Security |
| Quality of the tokens | Level | Level | Level |
| Low | Not allowed | 2 | 1 |
| Medium | 2 | 1 | 1 |
| High | 1 | 1 | 1 |

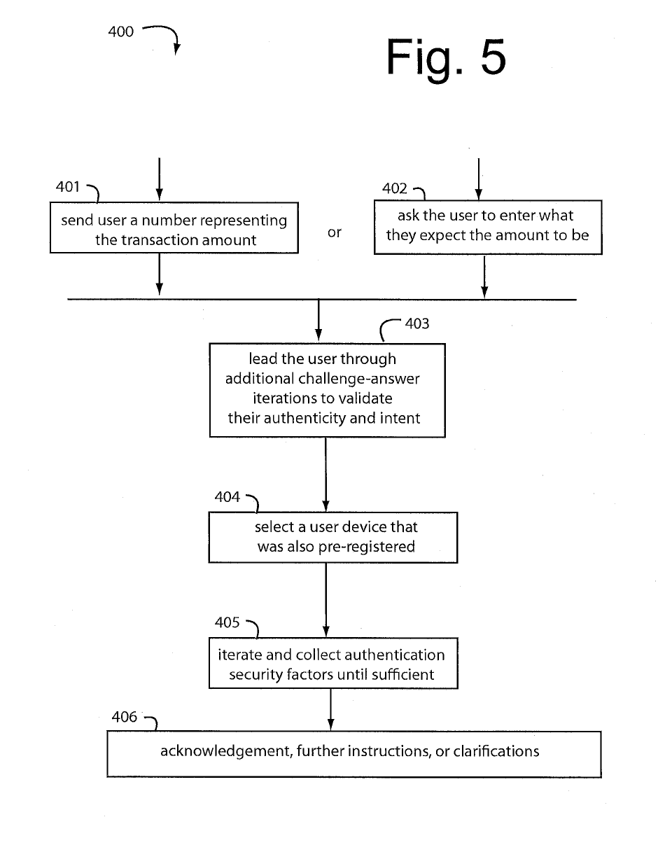

FIG. 5 represents another example scenario 400 compatible with certain embodiments described herein in which a shopper (e.g., user) uses more than one of their smart connected computing user devices, e.g., a phone, tablet, or PC, to make a purchase remote from a merchant's point of sale terminal (POS) or to engage in a transaction with a peer. For example, an on-line purchase is sometimes called a card-not-present transaction. In a step 401, the user receives the amount of the proposed transaction on their user device, or in a step 402 the user types in the amount of the proposed transaction. In a step 403, the user is led through a number of challenge-answer-comparison or forwarding iterations to validate their authenticity and intent. These communications can be conducted in a step 404 through parallel channels, e.g., a phone call, SMS text, email, or by connecting through another registered device available at the moment to the user. The user is therefore prompted to supply data for further authentication of the user, the device, and the transaction request message, in a step 405. After the transaction is authorized (e.g., a successful match of the one or more responses to the information derived from the one or more unique identifier datasets), the transaction proxy server computes the cryptographic information and generates a transaction signal indicative of approval of the transaction for completion and transmits the transaction signal to the payment processor. In certain embodiments, the user receives an acknowledgement, optionally with further instructions, in a step 406.

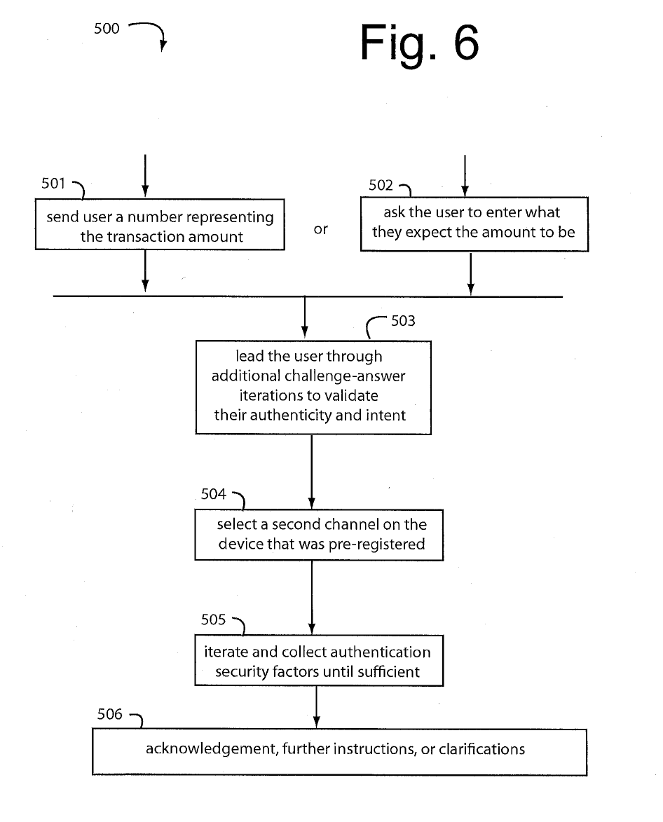

FIG. 6 represents another example scenario 500 compatible with certain embodiments described herein in which a shopper (e.g., user) has only one of their smart connected computing user devices on hand, e.g., a phone, tablet, or PC, and uses it to make a purchase remote from a merchant's point of sale terminal (POS) or to engage in a transaction with a peer (e.g., in a card-not-present transaction). In a step 501, the user receives the amount of the proposed transaction on their user device, or in a step 502 the user types in the amount of the proposed transaction. In a step 503, the user is led through a number of challenge-answer-comparison or forward iterations to validate their authenticity and intent. These communications can be conducted in a step 504 through parallel channels, e.g., a phone call, SMS text, email, but on a single user device like a smartphone. The user is prompted for further authentication of the user, the device, and the transaction request message, in a step 505. After the transaction is authorized (e.g., a successful match of the one or more responses to the information derived from the one or more unique identifier datasets), the transaction proxy server computes the cryptographic information and generates a transaction signal indicative of approval of the transaction for completion and transmits the transaction signal to the payment processor. In certain embodiments, the user receives an acknowledgement, optionally with further instructions, in a step 506.

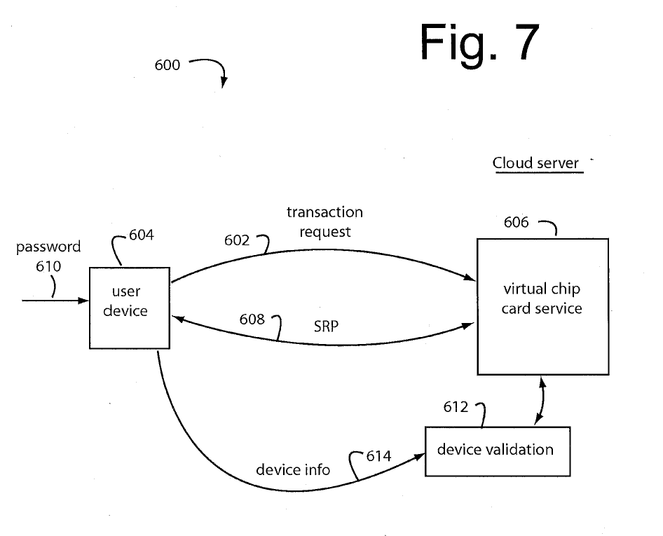

FIG. 7 represents an example, compatible with certain embodiments described herein, of how requests for transactions 602 (e.g., authorization messages) are forwarded by user devices 604 to a virtual chip card service 606, such as can be implemented with secure server 104 (e.g., a transaction proxy server) (FIGS. 1A-1B). The transaction requests 602 can be authenticable in many different ways. Each transmitted request and resulting session can be protected using secure remote password (SRP) protocol 608. SRP is a secure password-based authentication and key-exchange protocol. It can be used here to securely authenticate clients 604 to servers 606. The users of the client software can memorize a small secret, e.g., a password 610. The server verifies each user to authenticate the client. An attacker cannot impersonate the client because SRP exchanges a cryptographically-strong secret following a successful authentication. The mutual exchange enables the parties to securely communicate between themselves and to the exclusion of third parties. User devices can be validated 612 using (a) static device-specific information 614 such as device ID, IMEI, subscriber name, subscriber number, device specific serial numbers, etc.; or, (b) a secure signing service such as a trusted platform module (TPM) on the device for an appropriate authentication of the device protocol, such as in challenge-response, forwarding, Open Mobile Alliance-Digital Right Management (OMA-DRM) dedicated on-board chip, or on a programmable on-board chip.

Although described above in terms of particular embodiments, it is to be understood that the disclosure is illustrative and is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention as defined in the appended claims.

What is claimed is:

1. A transaction proxy server operatively coupled to the internet for authenticating authorization messages purporting to authorize transactions, the server comprising:
a memory device comprising cryptographic keys and a plurality of unique identifier datasets corresponding to a plurality of pre-registered user devices;
a plurality of user device communication channels operatively coupled via the internet to the plurality of pre-registered user devices, the plurality of user device communication channels configured to receive authorization messages from the plurality of pre-registered user devices, configured to transmit challenges to at least one user device of the plurality of pre-registered user devices, and configured to receive responses from the at least one user device;
a processor communication channel operatively coupled to the internet and configured to transmit transaction signals to a transaction processor; and
at least one processor operatively coupled to the plurality of user device communication channels and the processor communication channel, the at least one processor responsive to an authorization message, corresponding to a transaction and received from a user device of a user, by determining whether the user device is one of the plurality of pre-registered user devices, the at least one processor responsive to the user device being one of the plurality of pre-registered user devices by determining whether the transaction warrants additional authorization, the at least one processor responsive to the transaction warranting additional authorization by transmitting one or more challenges to one or more user devices of the user that are among the plurality of pre-registered user devices and receiving one or more responses from the one or more user devices of the user, the at least one processor further configured to compare the one or more responses to information derived from one or more unique identifier datasets corresponding to the one or more user devices of the user, the at least one processor responsive to a successful match of the one or more responses to the information by computing cryptographic information using the cryptographic keys and generating a transaction signal to be transmitted to the transaction processor, the transaction signal including the cryptographic information and indicative of approval of the transaction for completion.

2. The server of claim 1, wherein the at least one processor is responsive to the transaction not warranting additional authorization by computing the cryptographic information using the cryptographic keys and generating the transaction signal to be transmitted to the transaction processor, the transaction signal including the cryptographic information and indicative of approval of the transaction for completion.

3. The server of claim 1, wherein the at least one processor is responsive to an unsuccessful match of the one or more responses to the information by not generating the transaction signal.

4. The server of claim 1, wherein the unique identifier datasets comprise EMV-type data, the transaction signal comprises EMV-type data corresponding to the user device from which the authorization message was received and encoded using the cryptographic keys, and the transaction processor comprising an EMV payment processor configured to decode and use the EMV-type data.

5. The server of claim 1, wherein the processor communication channel is configured to transmit the transaction signals to the transaction processor without exposing the cryptographic keys to risk of disclosure to a third party.

6. The server of claim 1, further configured to receive securely transmitted personalization data from an issuing bank and to include the securely transmitted personalization data in the plurality of unique identifier datasets.

7. The server of claim 1, further configured to receive encoded unique identifiers from a user device to be registered as a pre-registered user device of the plurality of pre-registered user devices, to include the unique identifiers in the unique identifier dataset corresponding to the user device, to register the user device, and to include the user device in the plurality of pre-registered user devices.

8. The server of claim 7, wherein the authorization message is encoded by the user device using the unique identifiers and the at least one processor is configured to decode the authorization message using the unique identifiers.

9. The server of claim 7, further configured to transmit one or more challenges to the user device to be registered, to receive one or more responses to the one or more challenges from the user device, and to include the one or more responses in the unique identifier dataset corresponding to the user device.

10. The server of claim 1, wherein the unique identifier datasets comprise EMV-type data, biometric-template data, or both.

11. The server of claim 1, further comprising a tamper-resistant boundary within which the memory device is disposed.

12. The server of claim 1, wherein the at least one processor determines whether the transaction warrants additional authorization by scoring the transaction for risk using at least one of the following parameters: an amount of the transaction, a location of the transaction, and a type of the transaction.

13. The server of claim 1, wherein the one or more challenges are transmitted to one or more user devices of the user that are different from the user device from which the authorization message was received.

14. The server of claim 1, wherein the authorization message is received from a communication channel of the plurality of user device communication channels and the one or more challenges are transmitted via a different communication channel of the plurality of user device communication channels.

15. The server of claim 1, wherein the at least one processor iteratively determines whether the transaction warrants additional authorization, transmits the one or more challenges, receives the one or more responses, and compares the one or more responses to the information derived from the one or more unique identifier datasets corresponding to the one or more user devices of the user, until a predetermined authentication confidence level is reached.

16. The server of claim 1, wherein the one or more challenges comprises asking the user to state or accept an amount of the transaction.

17. A method of operating a transaction proxy server to authenticate authorization messages purporting to authorize transactions for completion, the server comprising a memory device comprising cryptographic keys and a plurality of unique identifier datasets corresponding to a plurality of pre-registered user devices, the method comprising:
receiving an authorization message from a user device of a user, the authorization signal corresponding to a transaction;
determining whether the user device is one of the plurality of pre-registered user devices;
in response to determining that the user device is one of the plurality of pre-registered user devices, determining whether the transaction warrants additional authorization;
in response to determining that the transaction warrants additional authorization, transmitting one or more challenges to one or more user devices of the user that are among the plurality of pre-registered user devices and receiving one or more responses from the one or more user devices of the user;
comparing the one or more responses to information derived from one or more unique identifier datasets corresponding to the one or more user devices of the user; and
in response to a successful match of the one or more responses to the information, computing cryptographic information using the cryptographic keys and generating a transaction signal including the cryptographic information and indicative of approval of the transaction for completion.

18. The method of claim 17, further comprising sending the transaction signal to a transaction processor.

19. The method of claim 17, wherein the authorization message is received via a first communication channel, the one or more challenges are transmitted via a second communication channel different from the first communication channel.

20. The method of claim 17, further comprising:
receiving encoded unique identifiers from at least one user device to be registered as at least one pre-registered user device of the plurality of pre-registered user devices;
including the unique identifiers in at least one unique identifier database corresponding to the at least one user device; and
registering the at least one user device and including the at least one user device in the plurality of pre-registered user devices.

21. The method of claim 17, further comprising transmitting one or more challenges to the at least one user device to be registered, receiving one or more responses to the one or more challenges from the at least one user device, and including the one or more responses in the at least one unique identifier dataset corresponding to the at least one user device.

22. The method of claim 17, wherein said determining whether the transaction warrants additional authorization, said transmitting one or more challenges, said receiving one or more responses, and said comparing are iteratively performed until a predetermined authentication confidence level is reached.
